(19) United States
(12) Patent Application Publication
(10) Pub. No.: US 2009/0222850 A1
(43) Pub. Date: Sep. 3, 2009

(54) ADVERTISEMENT SKIP VIEW

(75) Inventor: Michael J. Darnell, San Jose, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/041,606

(22) Filed: Mar. 3, 2008

(51) Int. Cl. H04N 7/10

(52) U.S. Cl. 725/32

(57) ABSTRACT

Advertisement skip view is described. In embodiment(s), a video stream of recorded media content can be distributed to a media device when requested at the media device to render as television media content for viewing. The recorded media content can include one or more advertisement pods that each include one or more advertisements. A skip command can be received from the media device to skip an advertisement in an advertisement pod that is rendered for viewing, such as when a viewer initiates a skip command at the media device. A focal position in a next advertisement in the advertisement pod can then be determined to skip to the focal position in the next advertisement. The recorded media content can then be distributed to the media device from the focal position in the next advertisement.

### BACKGROUND

Viewers have an ever-increasing selection of media content to choose from, such as television programming, on-demand movies and music, and/or recorded media content that is available for streaming from a content distributor to a media device. For example, scheduled television programming can be recorded at the time of broadcast when initially distributed for viewing, and can then be made available for on-demand viewing when requested via a media device. This is commonly referred to as Network Digital Video Recording (nDVR) and a viewer can request the recorded television content, such as movies and television programs, when convenient for the viewer.

Media content that is recorded from non-premium or subscription-based television channels generally includes advertisements. Many of the media devices that support playback of recorded media content, such as television client devices (e.g., a television set-top box, a digital video recorder (DVR), etc.), provide viewers with media content navigation features that are typically initiated with a remote control device. These media content navigation features include commands such as pause, fast-forward, rewind, and the like. Some of the media devices may also provide viewers with a thirty-second advance command that advances recorded media content thirty-seconds for each navigation input. While beneficial when used to shorten the time for viewing a recorded program, a “fast-forward” or other similar type of navigation advance input enables a viewer to bypass and ignore the advertisements that are included in the recorded media content between segments of a program.

These advertisement bypass features can be undesirable for advertisers, media content distributors, and viewers alike. The advertisements for products and services are typically a primary source of revenue for a distributor of the media content, and advertisers want viewers to see their advertisements. As more viewers attain the ability to bypass the advertisements in their programming choices, advertisers will become unwilling to have their advertising messages communicated in the traditional manner.

Some content distributors have opted to remove the thirty-second advance functionality from the remote control devices provided with the television client devices, leaving only the fast-forward function to advance ahead in a program. However, the fast-forward function does not provide a convenient media content advance function for skipping segments of a recorded program, such as television commercials. The video that is being displayed in a fast-forward mode must be observed by the viewer to input another remote control input, such as another fast-forward or play input, at precisely the right time to keep from overrunning a commercial and missing part of the program.

Although viewers may want to bypass the advertisements, some may still want to see at least a portion of an advertisement to discern whether a product or service offered in the advertisement may be of interest. The viewers may also want to bypass the advertisements without the complications of fast-forwarding, such as having to watch the display and initiate a play command before running past the advertisements, missing part of the desired programming, and then having to rewind the recorded media content.

### SUMMARY

This summary is provided to introduce simplified concepts of advertisement skip view. The simplified concepts are further described below in the Detailed Description. This summary is not intended to identify essential features of the claimed subject matter, nor is it intended for use in determining the scope of the claimed subject matter.

In embodiment(s) of advertisement skip view, a video stream of recorded media content can be distributed to a media device when requested at the media device to render as television media content for viewing. The recorded media content can include one or more advertisement pods that each include one or more advertisements. A skip command can be received from the media device to skip an advertisement in an advertisement pod that is rendered for viewing, such as when a viewer initiates a skip command at the media device. A focal position in a next advertisement in the advertisement pod can then be determined to skip to the focal position in the next advertisement. The recorded media content can then be distributed to the media device from the focal position in the next advertisement.

In other embodiment(s), a focal position in an advertisement can be determined as a beginning of the advertisement, an end of the advertisement, a position near the end of the advertisement, or any position in the advertisement that conveys the advertising message. When an advertisement skip command is received from a media device, a next advertisement can be rendered for viewing at the media device from the determined focal position in the next advertisement. A play command (or other designated command) may then be received from the media device as an indication to render the advertisement for viewing from the beginning of the advertisement, and the advertisement can then be provided for viewing from the beginning of the advertisement.

In other embodiment(s), it can also be determined that the advertisement being skipped is a last advertisement in the advertisement pod. If an advertisement skip command is received while the last advertisement is being rendered for viewing, the media device can be provided with the recorded media content from the end of the last advertisement. The media device can then render the recorded media content for viewing from the end of the last advertisement, which in one example, correlates to a beginning of a next segment of the desired programming after the advertisement pod of advertisements.

In other embodiment(s), an advertisement skip command can be received as an auto-skip command, in which case the advertisements in an advertisement pod can be sequentially skipped to the respective focal positions. When the last advertisement in the advertisement pod is determined, the media device can be provided with the recorded media content from the end of the last advertisement, and the media device can then render the recorded media content for viewing from the end of the last advertisement which may also correlate to a beginning of a segment of the desired programming.

### BRIEF DESCRIPTION OF THE DRAWINGS

Embodiments of advertisement skip view are described with reference to the following drawings. The same numbers are used throughout the drawings to reference like features and components:

FIG. 1 illustrates an example system in which embodiments of advertisement skip view can be implemented.

FIG. 2 illustrates another example system in which embodiments of advertisement skip view can be implemented.

FIG. 3 illustrates example method(s) for advertisement skip view in accordance with one or more embodiments.

FIG. 4 illustrates example method(s) for advertisement skip view in accordance with one or more embodiments.

FIG. 5 illustrates various components of an example device which can implement embodiments of advertisement skip view.

FIG. 6 illustrates various devices and components in an example media content distribution system in which embodiments of advertisement skip view can be implemented.

### DETAILED DESCRIPTION

Embodiments of advertisement skip view provide that a skip command can be received to skip to a focal position in an advertisement so that a viewer can see at least a portion of an advertisement to discern whether a product or service offered in an advertisement may be of interest. The viewer is given the ability to watch an entire advertisement if a product or service offered in the advertisement is of interest to the viewer. The advertisement skip view also provides that a viewer can see a portion of each advertisement yet, quickly advance through an advertisement pod of several advertisements, without having to initiate the fast-forward function (or a similar command). After quickly advancing through all of the advertisements in an advertisement pod, a viewer can advance to the beginning of desired programming without overrunning an advertisement or missing part of the desired programming.

While features and concepts of the described systems and methods for advertisement skip view can be implemented in any number of different environments, systems, and/or various configurations, embodiments of advertisement skip view are described in the context of the following example systems and environments.

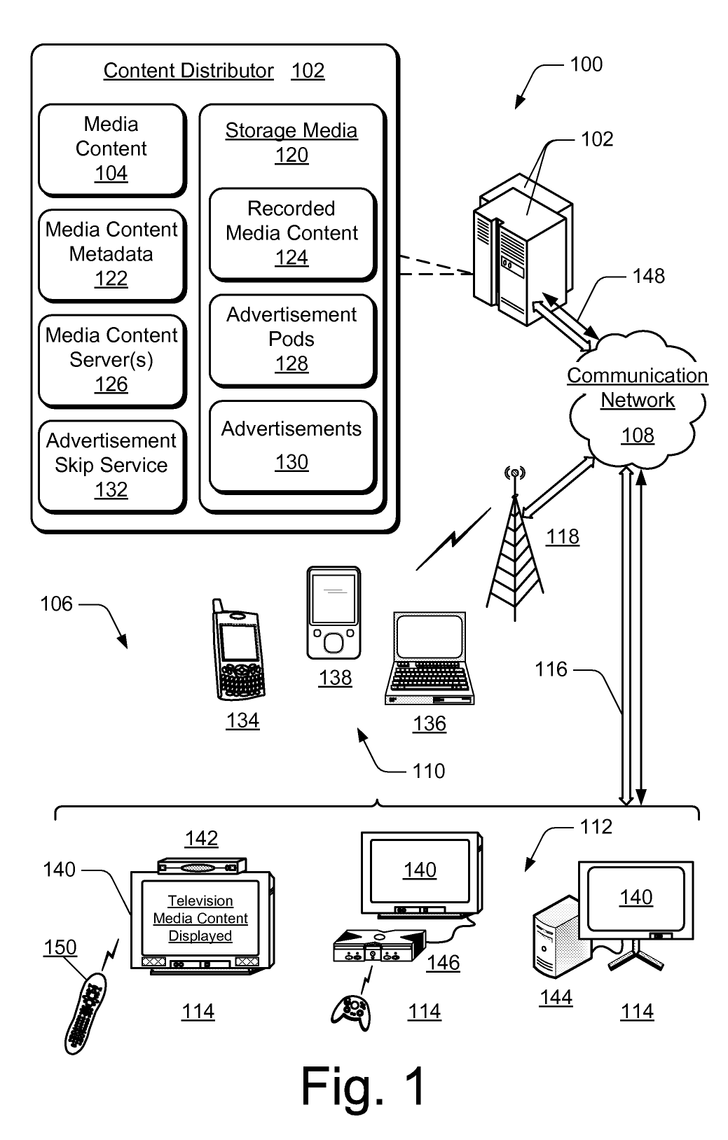

FIG. 1 illustrates an example system 100 in which various embodiments of advertisement skip view can be implemented. In this example, system 100 includes one or more content distributors 102 that communicate or otherwise provide media content 104 to any number of various media devices 106 via a communication network 108. The various media devices 106 can include wireless media devices 110 as well as other client devices 112 (e.g., wired and/or wireless devices) that are implemented as components in various client systems 114 in a media content distribution system.

The communication network 108 can be implemented to include a broadcast network, an IP-based network 116, and/or a wireless network 118 that facilitates media content distribution and data communication between the content distributors 102 and any number of the various media devices. The communication network 108 can also be implemented as part of a media content distribution system using any type of network topology and/or communication protocol, and can be represented or otherwise implemented as a combination of two or more networks.

In the example system 100, a content distributor 102 includes storage media 120 to store or otherwise maintain various data and media content, such as media content 104, media content metadata 122, and/or recorded media content 124 (e.g., recorded on-demand assets, recorded movies, recorded television programming, etc.). In a Network Digital Video Recording (nDVR) implementation, recorded on-demand assets can be recorded when initially distributed to the various media devices as scheduled television media content. The storage media 120 can be implemented as any type of memory, random access memory (RAM), a nonvolatile memory such as flash memory, read only memory (ROM), and/or other suitable electronic data storage. Content distributor 102 can also include one or more media content servers 126 that are implemented to communicate, or otherwise distribute, the media content 104, media content metadata 122, recorded media content 124, and/or other data to any number of the various media devices.

The media content 104 and/or recorded media content 124 can include any type of audio, video, and/or image media content received from any type of media content source. As described throughout, “media content” can include television programs (or programming), advertisements, commercials, music, movies, and on-demand media content. Other media content or recorded media content can include interactive games, network-based applications, and any other audio, video, and/or image content (e.g., to include program guide application data, user interface data, search results and/or recommendations, and the like).

The media content 104 and/or the recorded media content 124 can include desired programming (e.g., a television show, movie, or sporting event that a viewer desires to watch), as well as one or more advertisement pods 128. An advertisement pod 128 can include one or more advertisements 130 or commercials for various products and/or services. Thus, a video stream of recorded media content 124 that is distributed to a media device can include multiple segments of desired programming interspersed or separated by multiple advertisement pods 128, each having one or more advertisements 130.

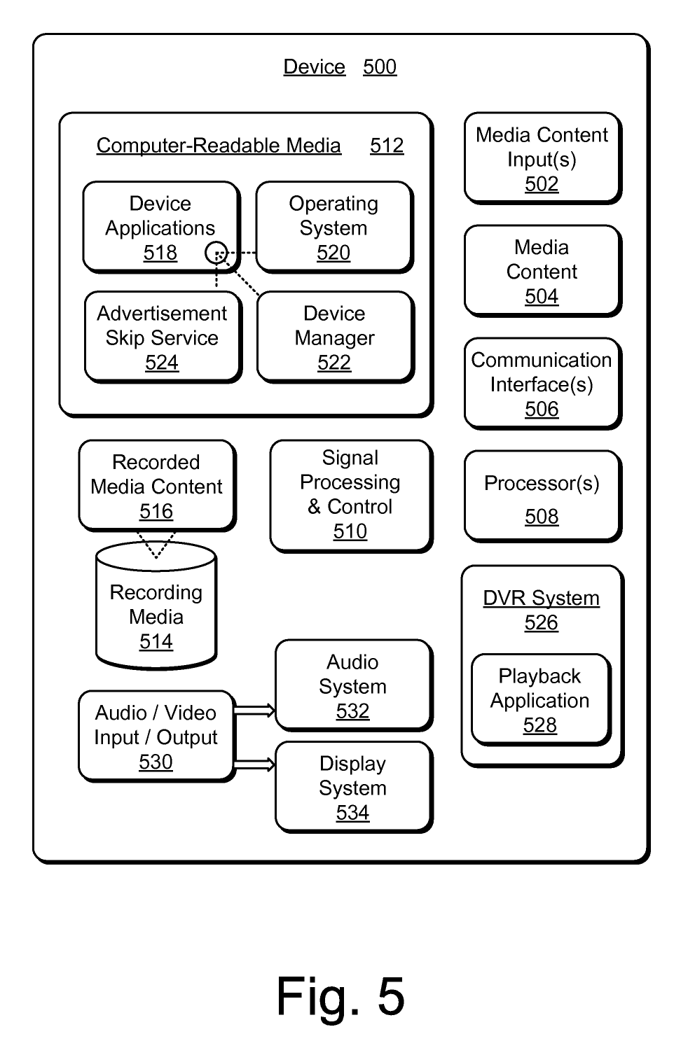

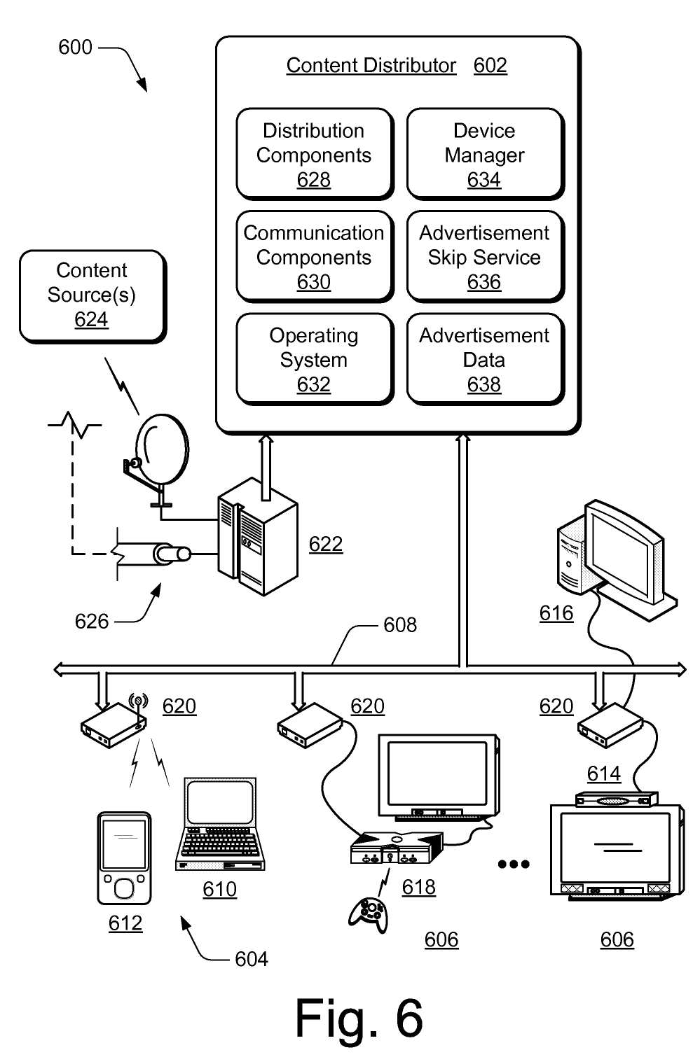

Content distributor 102 also includes an advertisement skip service 132 that can be implemented as computer-executable instructions and executed by processor(s) to implement the various embodiments and/or features described herein. In addition, a content distributor 102 can be implemented with any number and combination of differing components as further described with reference to the example device shown in FIG. 5 and/or the example content distributor shown in FIG. 6. The advertisement skip service 132, as well as other functionality described to implement embodiments of advertisement skip view, can also be provided as a service apart from the content distributor 102 (e.g., on a separate server or by a third party service).

The wireless media devices 110 can include any type of device implemented to receive and/or communicate wireless data, such as any one or combination of a mobile phone device 134 (e.g., cellular, VoIP, WiFi, etc.), a portable computer device 136, a media device 138 (e.g., a personal media player, portable media player, etc.), and/or any other wireless media device that can receive media content in any form of audio, video, and/or image data. Each of the client systems 114 include a respective client device and display device 140 that together render or playback any form of audio, video, and/or image media content.

A display device 140 can be implemented as any type of a television, high definition television (HDTV), LCD, or similar display system. A client device in a client system 114 can be implemented as any one or combination of a television client device 142 (e.g., a television set-top box, a digital video recorder (DVR), etc.), a computer device 144, a gaming system 146, an appliance device, an electronic device, and/or as any other type of client device that may be implemented to receive media content in any form of audio, video, and/or image data in a media content distribution system.

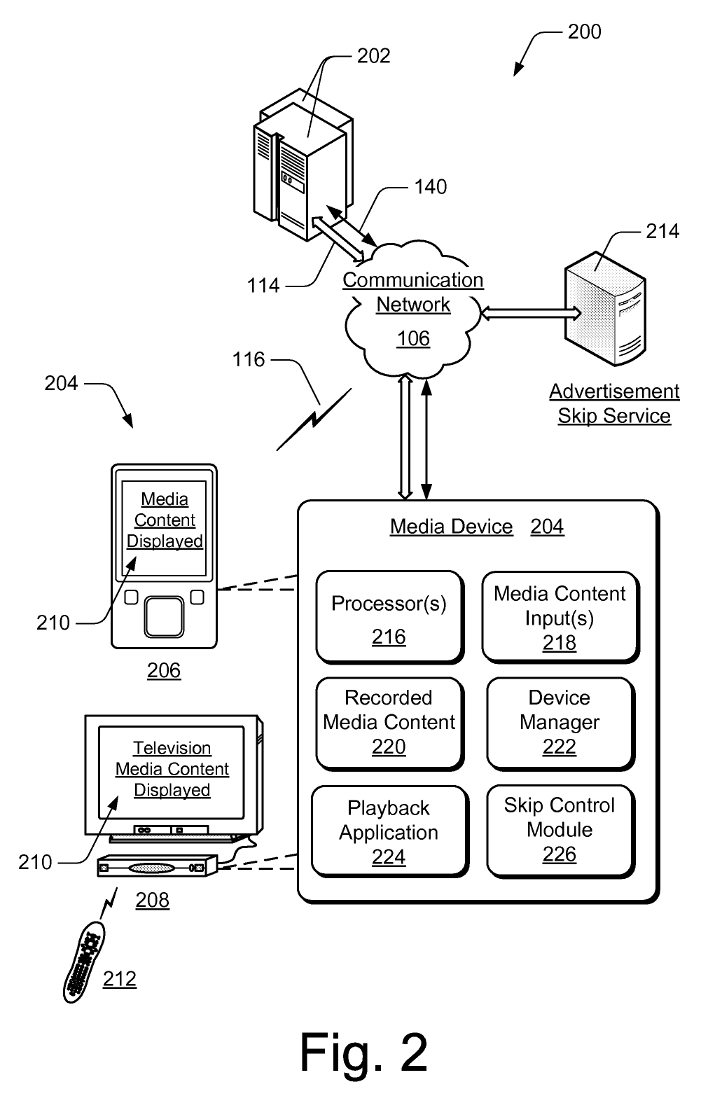

Any of the media devices can be implemented with one or more processors, communication components, memory components, signal processing and control circuits, and a media content rendering system. Further, any of the wireless media devices 110 and/or other client devices 112 can be implemented with any number and combination of differing components as further described with reference to the example media device shown in FIG. 2 and/or the example device shown in FIG. 5. A media device may also be associated with a user or viewer (i.e., a person) and/or an entity that operates the device such that a media device describes logical devices that include users, software, and/or a combination of devices.

Any of the wireless media devices 110 and/or other client devices 112 can communicate with any number of content distributors 102 via a two-way data communication link 148 of the communication network 108. It is contemplated that any one or more of the arrowed communication link 148, IP-based network 116, and wireless network 118, along with communication network 108, facilitate two-way data communication, such as from a media device to a content distributor 102 and vice-versa.

The advertisement skip service 132 at content distributor 102 can be implemented to receive a skip command from a media device 106 and skip an advertisement 130 in an advertisement pod 128 that is rendered for viewing at the media device. When a skip command is received from the media device 106, the advertisement skip service 132 can determine a focal position in a next advertisement in the advertisement pod 128 that follows the advertisement 130 which is being skipped. The advertisement skip service 132 can then skip to the focal position in the next advertisement in the advertisement pod 128 so that the recorded media content 124 can be distributed to the media device from the focal position in the next advertisement.

A focal position can be defined as a position in an advertisement 130 that may convey a message of the advertisement and/or content that is likely of interest to viewers. The focal position in an advertisement may also be the position designated, or otherwise desired, as the position in the advertisement that an advertiser would want viewers to see. When an advertisement is rendered for viewing for a short period of time from the focal position, the message of the advertisement and/or the interesting content can be conveyed to a viewer. Thus, rendering a video stream of recorded media content 124 from a focal position of an advertisement may include one or more images, sounds, words, graphics, video, and/or other context that quickly convey the message of the advertisement and/or other interesting content to a viewer. This allows a viewer to receive advertising messages while skipping through advertisements that are included with desired programming.

The advertisement skip service 132 can determine a beginning and/or an end of an advertisement 130. Accordingly, the advertisement skip service can be implemented to determine one or various focal positions in an advertisement. In one embodiment, the advertisement skip service 132 can be implemented to determine that a focal position in a next advertisement is a beginning of the next advertisement or a position near the beginning of the next advertisement in an advertisement pod 128. In another embodiment, the advertisement skip service 132 can be implemented to determine that a focal position in a next advertisement is an end of the next advertisement or a position near an end of the next advertisement in the advertisement pod 128. For example, a position near an end of the next advertisement could be a position that is approximately ten seconds, five seconds, or one second before the end of the next advertisement.

In some instances it may be desirable to skip to a focal position in an advertisement that is currently being rendered. For example, if a focal position is at a position near an end of an advertisement that is currently being rendered for viewing, yet the advertisement is currently being rendered from the beginning, it may be desirable to skip to the focal position of the advertisement. Accordingly, in yet another embodiment, the advertisement skip service 132 can be implemented to first determine whether the focal position of a current advertisement has been rendered for viewing. If the focal position in the current advertisement has not been rendered for viewing, the advertisement skip service 132 can be implemented to determine that the focal position is at a beginning, an end, or position near a beginning or an end of the advertisement that is currently being rendered. If, on the other hand, the focal position in the current advertisement has been rendered for viewing, the advertisement skip service 132 can determine a focal position in the next advertisement.

In some embodiments, the location of a focal position in an advertisement can be defined by the content distributor 102. For example, a focal position in an advertisement can be defined as a beginning of an advertisement for all advertisements. In this case, advertisers that desire to take advantage of the advertisement skip service 132 can create an advertising message and/or interesting content at the beginning of their advertisements. In other embodiments, the location of the focal position in an advertisement can be defined by the advertiser that provides the advertisement. In this case, the advertisement skip service 132 can be implemented to determine, from the advertisements, different focal positions for the different advertisements. For example, advertisement skip service 132 can be implemented to determine a focal position at a beginning of a first advertisement in an advertisement pod, and a focal position near an end of a second advertisement in the advertisement pod.

When an advertisement skip command is received by the advertisement skip service 132, a next advertisement can be rendered for viewing at a media device 106 from the focal position in the next advertisement. For example, if the focal position is at a beginning of an advertisement, a viewer who wishes to view the entirety of the advertisement can simply watch the advertisement from the beginning of the advertisement. However, in embodiments where the focal position is at a position other than the beginning of an advertisement (e.g., at a position near the end of an advertisement), the advertisement skip service 132 can be implemented to receive a play command from a media device 106 as an indication to render the advertisement for viewing from the beginning of the advertisement. The advertisement can then be provided by the content distributor 102 for viewing from the beginning of the advertisement.

When an advertisement is rendered for viewing from a focal position near the end of an advertisement, a viewer may desire to watch the entire advertisement. To do so, a viewer can simply press a play button (or another designated input button) on a remote input device 150 to initiate a video “play” command, and the advertisement skip service 132 can deliver the video stream to play the advertisement from the beginning of the advertisement. This embodiment is desirable for both advertisers, who want viewers to watch their advertisements, and viewers, who may only want to watch advertisements for products and/or from advertisers that are of interest to them. This also creates an incentive for advertisers to concentrate their efforts on providing interesting content at the focal position of their advertisements so that viewers will be enticed to watch the entire advertisement.

In other embodiments, advertisement skip service 132 can be implemented to determine that a skip command is received while a last advertisement 130 in an advertisement pod 128 is being rendered for viewing by a media device 106. A last advertisement in an advertisement pod may also be referred to as the advertisement that is directly before the next segment of desired programming. When a skip command is received while the last advertisement in an advertisement pod 128 is being rendered for viewing, the advertisement skip service 132 can skip to the end of the advertisement being rendered, which may also correlate to a beginning of a next segment of the desired programming. The content distributor 102 can then distribute the recorded media content 124 from the end of the last advertisement so that the media device 106 can render the desired programming for viewing.

In other embodiments, the advertisement skip service 132 can receive an auto-skip command, in which case the advertisement skip service 132 can be implemented to sequentially skip to a focal position in a next advertisement for each of the advertisements in an advertisement pod 128. When a last advertisement in the advertisement pod is determined, the advertisement skip service 132 can skip to the end of the last advertisement, so that the content distributor 102 can then distribute the recorded media content 124 from the end of the last advertisement in the advertisement pod 128, which may also correlate to a beginning of a next segment of the desired programming. Advertisement skip service 132 can be implemented to distribute each advertisement being skipped from the focal position for a predetermined time, such as for one second or five seconds. This may enable advertisers to quickly convey an advertising message to viewers, and will allow the viewers to quickly skip through the advertisements 130 in an advertisement pod 128.

Although illustrated and described as a component or module of the content distributor 102, the advertisement skip service 132 can be implemented as an independent service to implement embodiments of advertisement skip view. Further, although the advertisement skip service 132 is illustrated and described as a single component or module, the advertisement skip service 132 can be implemented as several component applications or modules distributed to implement various embodiments of advertisement skip view as described herein.

FIG. 2 illustrates an example system 200 in which various embodiments of advertisement skip view can be implemented. In this example, system 200 includes one or more content distributors 202 and examples of wired and/or wireless media devices 204, such as a portable media device 206 and a television client device 208. A media device 204 can display various types of media content 210 (to include television media content). A viewer can interact with a media device 204 and initiate user inputs and selections of various media content navigation commands, such as on the portable media device 206 or with a remote control input device 212.

An example of a content distributor is described with reference to content distributor 102 shown in FIG. 1. However, in this example system 200, an advertisement skip service 214 is independent and implemented apart from content distributor 202 (e.g., on a separate server or by a third party service). The advertisement skip service 214 can be implemented as an optional service and/or as a service that users pay for to receive advertisement skip controls and/or any of the features and aspects of advertisement skip view. The advertisement skip service 214 can implement any of the techniques described above with reference to the advertisement skip service 132 shown in FIG. 1. The content distributor 202, advertisement skip service 214, and the media devices 204 can all be implemented for communication with each other via the communication network 108, the IP-based network 116, and/or the wireless network 118.

In the example system 200, a media device 204 includes one or more processors 216 (e.g., any of microprocessors, controllers, and the like), media content inputs 218, and recorded media content 220 (e.g., media content that has been received and recorded, recorded media content that is being received, recommended media content, etc.). The media content inputs 218 can include any type of wireless, broadcast, and/or over-the-air inputs via which media content is received.

Media device 204 can also include a device manager 222 (e.g., a control application, software application, signal processing and control module, etc.) that can be implemented as computer-executable instructions and executed by the processors 216 to implement various embodiments and/or features of advertisement skip view. The device manager 222 can be implemented to monitor and/or receive selectable inputs (e.g., viewer selections, navigation inputs, etc.) via an input device 212, and initiate communication of user selections back to a content distributor 202 and/or the advertisement skip service 214.

Media device 204 can also include a playback application 224 that can be implemented as computer-executable instructions and executed by the processors 216 to implement various embodiments and/or features of advertisement skip view. The playback application 224 can be implemented as a media control application to control the playback of recorded media content 220 and/or any other audio, video, and/or image media content that can be rendered and/or displayed for viewing at or in association with a media device 204.

Media device 204 can also include a skip control module 226 that is local to a specific media device to implement any of the features and aspects of advertisement skip view. The skip control module 226 can implement any of the techniques described above with reference to the advertisement skip service 132 shown in FIG. 1. The skip control module 226 at media device 204 can be implemented to receive a skip command, such as from remote control input device 212, and skip an advertisement in an advertisement pod that is rendered for viewing by the media device. When the skip command is received at the media device 201, the skip control module 226 can determine a focal position in a next advertisement in the advertisement pod that follows the advertisement which is being skipped. The skip control module 226 can then skip to the focal position in the next advertisement in the advertisement pod so that the recorded media content 220 can be rendered for viewing from the focal position in the next advertisement.

The skip control module 226 can determine a beginning and/or an end of an advertisement. Accordingly, the skip control module can be implemented to determine one or various focal positions in an advertisement. In one embodiment, the skip control module 226 can be implemented to determine that a focal position in a next advertisement is a beginning of the next advertisement or a position near the beginning of the next advertisement in an advertisement pod. In another embodiment, the skip control module 226 can be implemented to determine that a focal position in a next advertisement is an end of the next advertisement or a position near an end of the next advertisement in the advertisement pod. For example, a position near an end of the next advertisement could be a position that is approximately ten seconds, five seconds, or one second before the end of the next advertisement. In some instances it may be desirable to skip to a focal position in the advertisement that is currently being rendered. Accordingly, in yet another embodiment, the skip control module 226 can be implemented to determine that a focal position is at a beginning, an end, or position near a beginning or an end of the advertisement that is currently being rendered.

When an advertisement skip command is received by the skip control module 226, a next advertisement can be rendered for viewing from the focal position in the next advertisement. If the focal position is at a beginning of an advertisement, a viewer who wishes to view the entirety of the advertisement can simply watch the advertisement from the beginning of the advertisement. However, in embodiments where the focal position is at a position other than the beginning of an advertisement, the skip control module 226 can be implemented to receive a play command from remote control input device 212 as an indication to render the advertisement for viewing from the beginning of the advertisement. The advertisement can then be rendered for viewing from the beginning of the advertisement.

In other embodiments, advertisement skip control module 226 can be implemented to determine that a skip command is received while a last advertisement in an advertisement pod is being rendered for viewing by a media device 204. When a skip command is received while the last advertisement in the advertisement pod is being rendered for viewing, the skip control module 226 can skip to the end of the advertisement being rendered, which may also correlate to a beginning of a next segment of the desired programming that a viewer wants to watch. The playback application 224 can then initiate that the recorded media content 220 be rendered for viewing from the end of the last advertisement

In other embodiments, the skip control module 226 can receive an auto-skip command, in which case the skip control module 226 can be implemented to sequentially skip to a focal position in a next advertisement for each of the advertisements in an advertisement pod. When a last advertisement in the advertisement pod is determined, the skip control module 226 can skip to the end of the last advertisement, so that the recorded media content 220 can be rendered for viewing from the end of the last advertisement in the advertisement pod, which may also correlate to a beginning of a next segment of the desired programming. Skip control module 226 can initiate the playback application 224 to render each advertisement being skipped for a predetermined time, such as for one second or five seconds. This may enable advertisers to quickly convey an advertising message to viewers, and will allow the viewers to quickly skip through the advertisements in an advertisement pod.

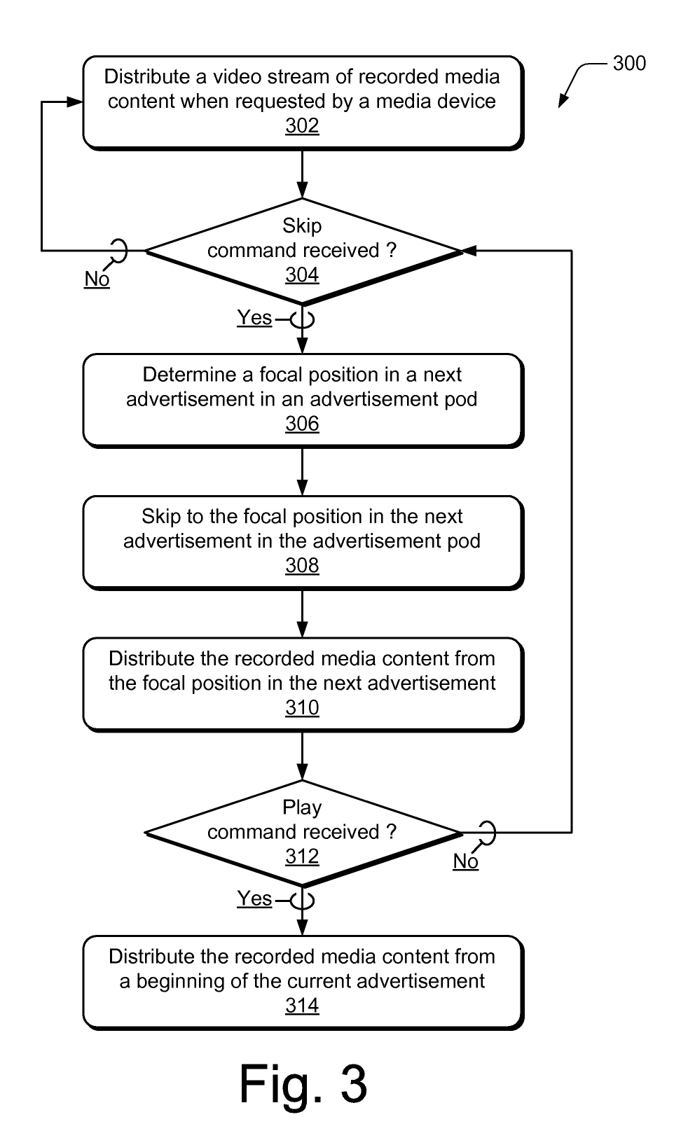

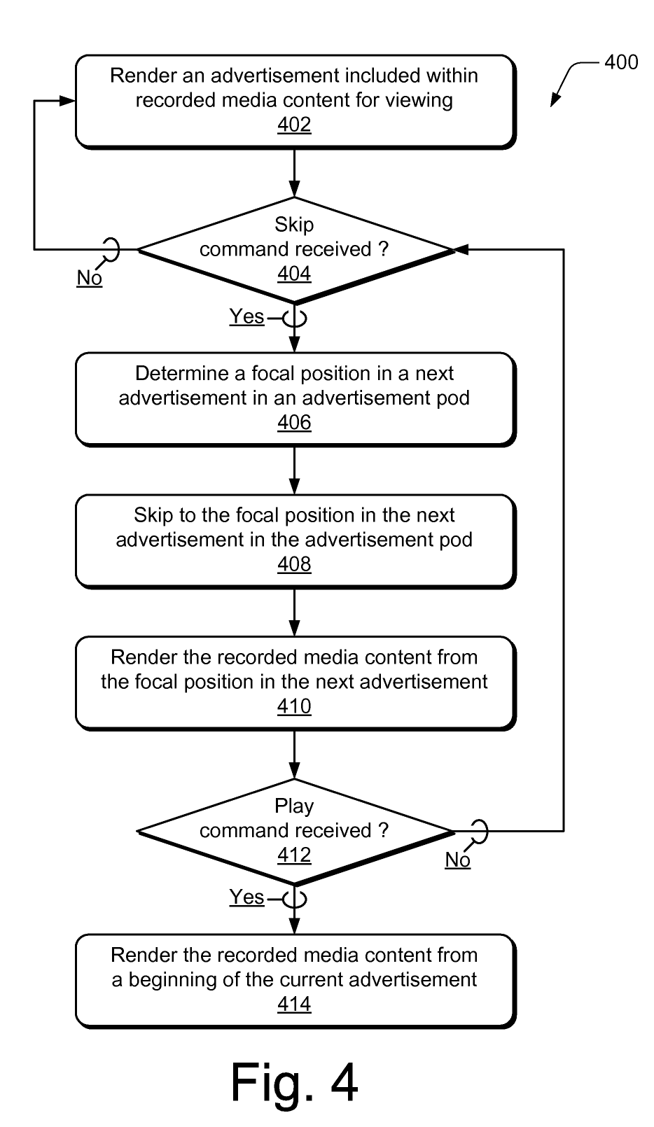

Example methods 300 and 400 are described with reference to respective FIGS. 3 and 4 in accordance with one or more embodiments of advertisement skip view. Generally, any of the functions, methods, procedures, components, and modules described herein can be implemented using hardware, software, firmware (e.g., fixed logic circuitry), manual processing, or any combination thereof. A software implementation of a function, method, procedure, component, or module represents program code that performs specified tasks when executed on a computing-based processor. Example methods 300 and 400 may be described in the general context of computer-executable instructions. Generally, computer-executable instructions can include software, applications, routines, programs, objects, components, data structures, procedures, modules, functions, and the like.

The method(s) may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 of advertisement skip view. The order in which the method is described is not intended to be construed as a limitation, and any number of the described method blocks can be combined in any order to implement the method, or an alternate method.

At block 302, a video stream of recorded media content is distributed when requested by a media device. For example, the content distributor 102 (FIG. 1) distributes recorded media content 124 to various media devices 106, such as wireless media devices 110 and/or other client devices 112. In one instance, the recorded media content 124 is distributed to a media device 106 as a video stream that includes a requested program (e.g., a recorded television program, a recorded movie, or other recorded media content requested by a viewer), and includes advertisement pods 128 that each have one or more advertisements 130. The advertisement pods 128 are included around, or interspersed between, various segments of the requested program.

At block 304, a determination is made as to whether a command to skip an advertisement is received. For example, the advertisement skip service 132 at content distributor 102 can receive a skip command from a media device 106 to skip an advertisement that is currently being rendered for viewing. If a skip command is not received (i.e., “no” from block 304), then the method continues at block 302 to distribute the video stream of recorded media content to the media device.

If a skip command is received (i.e., “yes” from block 304) then at block 306, a focal position in a next advertisement in an advertisement pod is determined. For example, the advertisement skip service 132 at content distributor 102 determines a focal position in a next advertisement in the advertisement pod. A focal position can be determined as a beginning (or a position near a beginning), an end (or a position near an end), or any other position in any advertisement in the advertisement pod. As discussed above, a focal position may be a position in an advertisement that conveys a message of the advertisement or content that is likely to be of interest to viewers.

At block 308, the focal position in the next advertisement in the advertisement pod is skipped to and, at block 310, the recorded media content is distributed from the focal position in the next advertisement. For example, the advertisement skip service 132 skips to the focal position in the next advertisement in the advertisement pod 128, and then initiates that the media content servers 126 distribute the recorded media content 124 from the focal position in the next advertisement in the advertisement pod.

At block 312, a determination is made as to whether a command to play an advertisement is received. For example, a user or viewer at a wireless media device 110 or client device 112 can request to play an advertisement, that is currently being rendered for viewing, from the beginning of the advertisement. If a play command (or other designated command) is not received (i.e., “no” from block 312), then the method continues at block 304 to determine whether a subsequent skip command is received. If a play command (or other designated command) is received (i.e., “yes” from block 312), then at block 314, the recorded media content is distributed from the beginning of the current advertisement. For example, the advertisement skip service 132 initiates the media content servers 126 at content distributor 102 to distribute the recorded media content 124 from the beginning of the advertisement that is currently being rendered for viewing at the media device.

FIG. 4 illustrates example method(s) 400 of advertisement skip view. The order in which the method is described is not intended to be construed as a limitation, and any number of the described method blocks can be combined in any order to implement the method, or an alternate method.

At block 402, an advertisement that is included within recorded media content is rendered for viewing. For example, the media device 204 (FIG. 2) renders recorded media content 220 which includes a requested program (e.g., a recorded television program, a recorded movie, or other recorded media content requested by a viewer), and includes advertisement pods 128 that each have one or more advertisements 130. The advertisement pods 128 are included around, or interspersed between, various segments of the requested program.

At block 404, a determination is made as to whether a command to skip an advertisement is received. For example, a user or viewer at media device 204 can initiate a request to skip an advertisement that is currently being rendered for viewing via user inputs or remote control device 212. The skip control module 226, or the advertisement skip service 214, receives the skip command to skip the advertisement that is currently being rendered for viewing. If a skip command is not received (i.e., “no” from block 404), then the method continues at block 402 to render the recorded media content.

If a skip command is received (i.e., “yes” from block 404) then at block 406, a focal position in a next advertisement in an advertisement pod is determined. For example, the skip control module 226 at media device 204 (or the advertisement skip service 214) determines a focal position in a next advertisement in the advertisement pod. A focal position can be determined as a beginning (or a position near a beginning), an end (or a position near an end), or any other position in a current or a next advertisement in the advertisement pod. As discussed above, a focal position may be a position in an advertisement that conveys the message of the advertisement or content that is likely to be of interest to viewers.

At block 408, the focal position in the next advertisement in the advertisement pod is skipped to, and at block 410, the recorded media content is rendered for viewing. For example, the skip control module 226 skips to the focal position in the next advertisement in the advertisement pod, and then initiates that the media device 204 render the recorded media content 220 from the focal position in the next advertisement in the advertisement pod.

At block 412, a determination is made as to whether a command to play an advertisement is received. For example, a user or viewer can request to play an advertisement, that is currently being rendered for viewing, from the beginning of the advertisement using user inputs or remote control device 212. If a play command (or other designated command) is not received (i.e., “no” from block 412), then the method continues at block 404 to determine whether a subsequent skip command is received. If a play command (or other designated command) is received (i.e., “yes” from block 412), then at block 414, the recorded media content is rendered for viewing from the beginning of the current advertisement. For example, the skip control module 226 at media device 204 (or the advertisement skip service 214) initiates playback of the current advertisement from the beginning of the advertisement.

FIG. 5 illustrates various components of an example device 500 that can be implemented as any form of a computing, electronic, appliance, and/or media device to implement various embodiments of advertisement skip view. For example, device 500 can be implemented as a content distributor, an advertisement skip service, and/or a media device as shown in FIG. 1 and/or FIG. 2. In various embodiments, device 500 can be implemented as any one or combination of a wired and/or wireless media device, a mobile phone device, a portable computer device, a television client device (e.g., a television set-top box, a digital video recorder (DVR), etc.), a computer device, a gaming system, an appliance device, an electronic device, and/or as any other type of media that may be implemented to receive media content in any form of audio, video, and/or image data.

Device 500 can include one or more media content inputs 502 via which any type of audio, video, and/or image media content 504 can be received from a media content source. The media content inputs 502 can include Internet Protocol (IP) inputs over which streams of media content are received via an IP-based network. Device 500 further includes one or more communication interfaces 506 that can be implemented as any one or more of a serial and/or parallel interface, a wireless interface, any type of network interface, a modem, and as any other type of communication interface. The communication interfaces 506 provide a connection and/or communication links between device 500 and a communication network by which other electronic, computing, and communication devices can communicate data with device 500.

Device 500 can include one or more processors 508 (e.g., any of microprocessors, controllers, and the like) which process various computer-executable instructions to control the operation of device 500, to communicate with other electronic and computing devices, and to implement embodiments of advertisement skip view. Alternatively or in addition, device 500 can be implemented with any one or combination of hardware, firmware, or fixed logic circuitry that is implemented in connection with signal processing and control circuits which are generally identified at 510.

Device 500 can also include computer-readable media 512, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like. Device 500 may also include a recording media 514 to maintain recorded media content 516 (e.g., recorded on-demand media content, or assets) that device 500 receives and/or records.

Computer-readable media 512 provides data storage mechanisms to store media content 504, as well as various device applications 518 and any other types of information and/or data related to operational aspects of device 500. For example, an operating system 520 can be maintained as a computer application with the computer-readable media 512 and executed on the processors 508. The device applications 518 can also include a device manager 522 when device 500 is implemented as a media device and/or as a content distributor, and can include an advertisement skip service 524 when device 500 is implemented as a content distributor. In this example, the device applications 518 are shown as software modules and/or computer applications that can implement various embodiments of advertisement skip view.

When implemented as a television client device, the device 500 can also include a DVR system 526 with a playback application 528 that can be implemented as a media control application to control the playback of recorded media content 516 and/or any other audio, video, and/or image media content 504 that can be rendered and/or displayed for viewing. The recording media 514 can maintain recorded media content that may include the media content 504 when it is received from a content distributor and recorded. For example, the media content 504 can be recorded when received as a viewer-scheduled recording, or when the recording media 514 is implemented as a pause buffer that records the media content 504 as it is being received and rendered for viewing.

Device 500 can also include an audio and/or video input/output system 530 that provides audio data to an audio rendering system 532 and/or provides video data to a display system 534. The audio rendering system 532 and/or the display system 534 can include any devices that process, display, and/or otherwise render audio, video, and image data. Video signals and audio signals can be communicated from device 500 to an audio device and/or to a display device via an RF (radio frequency) link, S-video link, composite video link, component video link, DVI (digital video interface), analog audio connection, or other similar communication link. In an embodiment, audio rendering system 532 and/or the display system 534 can be implemented as external components to device 500. Alternatively, the audio rendering system 532 and/or the display system 534 can be implemented as integrated components of the example device 500.

Although not shown, device 500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

FIG. 6 illustrates an example media content distribution system 600 in which various embodiments of advertisement skip view can be implemented. System 600 facilitates the distribution of media content, content metadata, and/or other associated data to multiple viewers, users, viewing systems, and devices. System 600 includes a content distributor 602 and any number of wired and/or wireless media devices. The media devices can include wireless media devices 604 as well as other client devices that are implemented as components in various client systems 606, each configured for data communication via a communication network 608. Each of the media devices and other client devices can receive media content, program content, program guide data, advertising content, closed captions data, content metadata, and the like from content server(s) of the content distributor 602 via the communication network 608.

The wireless media devices 604 can include any type of device implemented to receive and/or communicate wireless data, such as a portable computer device 610, a media device 612 (e.g., a personal media player, portable media player, etc.), and/or any other wireless media device that can receive content in any form of audio, video, and/or image media content. Each of the client systems 606 can include a respective client device and display device that together render media content in any form of audio, video, and/or image data. A client device in a client system 606 can be implemented as any one or combination of a television client device 614 (e.g., a television set-top box, a digital video recorder (DVR), etc.), a computer device 616, a gaming system 618, an appliance device, an electronic device, and/or as any other type of client device that may be implemented to receive any form of audio, video, and/or image media content.

The communication network 608 can be implemented as any one or combination of a wide area network (e.g., the Internet), a local area network (LAN), an intranet, an IP-based network, a broadcast network, a wireless network, a Digital Subscriber Line (DSL) network infrastructure, a point-to-point coupling infrastructure, or as any other media content distribution network. Additionally, communication network 608 can be implemented using any type of network topology and any network communication protocol, and can be represented or otherwise implemented as a combination of two or more networks. A digital network can include various hardwired and/or wireless links 620, such as routers, gateways, and so on to facilitate communication between content distributor 602 and the various media devices.

System 600 includes a media server 622 that receives content from various content sources 624, such as media content from a content provider, program guide data from a program guide source, and advertising content from an advertisement provider. The media server 622 can represent an acquisition server that receives audio, video, and/or image media content from a content provider; an EPG server that receives program guide data from a program guide source; and/or an advertising management server that receives advertising content from an advertisement provider.

The content sources 624 control distribution of the media content, the program guide data, and the advertising content to the media server 622 and/or to other servers of system 600. The media content, program guide data, and advertising content can be distributed via various transmission media 626, such as satellite transmission, radio frequency transmission, cable transmission, and/or via any number of other wired or wireless transmission media. In this example, media server 622 is shown as an independent component of system 600 that communicates the media content, program guide data, and advertising content to content distributor 602. In an alternate implementation, media server 622 can be implemented as a component of content distributor 602.

Content distributor 602 is representative of a headend service in a content distribution system, for example, that provides the media content, program guide data, advertising content, and content metadata to multiple subscribers (e.g., the various media devices and client systems 606). The content distributor 602 can be implemented as a satellite operator, a network television operator, a cable operator, and the like to control distribution of media content, program and advertising content, and any other audio, video, and/or image content to the media devices and client systems 606.

Content distributor 602 includes various content distribution components 628 to facilitate media content processing and distribution, such as a subscriber manager, a device monitor, and one or more content servers. The subscriber manager manages subscriber data, and the device monitor maintains client state information and monitors the media devices, client devices, and/or the client systems. Although the various managers, servers, and monitors of content distributor 602 (to include the media server 622 in one embodiment) are described as distributed, independent components, any one or more of the managers, servers, and monitors can be implemented together as a multi-functional component of content distributor 602. Additionally, any one or more of the managers, servers, and monitors described with reference to system 600 can implement features and embodiments of advertisement skip view.

The content distributor 602 can also include communication components 630 that are implemented to facilitate media content distribution to the various media devices and other client devices via the communication network 608. The content distributor 602 can also include one or more processors to process various computer-executable instructions, such as an operating system 632, a device manager 634, and an advertisement skip service 636. The content distributor 602 can also include computer-readable media for data storage to maintain advertisement data 638 for embodiments of advertisement skip view.

Although embodiments of advertisement skip view have been described in language specific to features and/or methods, it is to be understood that the subject of the appended claims is not necessarily limited to the specific features or methods described. Rather, the specific features and methods are disclosed as example implementations of advertisement skip view.

1. A method, comprising:
distributing a video stream of recorded media content to a media device when requested by the media device to render as television media content for viewing, the recorded media content including one or more advertisement pods that each include one or more advertisements;
receiving a skip command from the media device to skip an advertisement in an advertisement pod that is rendered for viewing at the media device;
determining a focal position in a next advertisement in the advertisement pod that follows the advertisement which is being skipped;
skipping to the focal position in the next advertisement in the advertisement pod; and
distributing the recorded media content to the media device from the focal position in the next advertisement.

2. A method as recited in claim 1, wherein the focal position is a beginning of the next advertisement.

3. A method as recited in claim 1, further comprising determining an end of the next advertisement, and wherein the focal position includes a position near the end of the next advertisement.

4. A method as recited in claim 3, wherein the focal position is approximately five seconds from the end of the next advertisement.

5. A method as recited in claim 1, further comprising:
receiving a play command from the media device to initiate rendering said next advertisement for viewing at the media device after said skipping to the focal position in the next advertisement; and
distributing the video stream to the media device from a beginning of said next advertisement.

6. A method as recited in claim 1, further comprising:
determining whether the advertisement that is being skipped is a last advertisement in the advertisement pod;
skipping to an end of the last advertisement if the advertisement that is being skipped is the last advertisement in the advertisement pod; and
distributing the video stream to the media device from the end of the last advertisement in the advertisement pod.

7. A method as recited in claim 1, wherein the skip command is received as an auto-skip command, the method further comprising:
repeating said determining a respective focal position in each subsequent advertisement in the advertisement pod and said skipping to the focal position in the next advertisement until the next advertisement is a last advertisement in the advertisement pod;
skipping to an end of the last advertisement in the advertisement pod; and
distributing the video stream to the media device from the end of the last advertisement in the advertisement pod.

8. A content distributor, comprising:
a storage media configured to maintain recorded media content that can be requested by media devices to render as television media content for viewing, the recorded media content being recorded when initially distributed to the media devices as scheduled television media content;
a media content server configured to distribute a video stream of the recorded media content to a media device when requested, the recorded media content including one or more advertisement pods that each include one or more advertisements;
an advertisement skip service configured to:
receive a skip command from the media device to skip an advertisement in an advertisement pod that is rendered for viewing at the media device;
determine a focal position in a next advertisement in the advertisement pod that follows the advertisement which is being skipped; and
skip to the focal position in the next advertisement in the advertisement pod to distribute the video stream to the media device from the focal position in the next advertisement.

9. A content distributor as recited in claim 8, wherein the focal position is a beginning of the next advertisement.

10. A content distributor as recited in claim 8, wherein the advertisement skip service is further configured to determine an end of the next advertisement, and wherein the focal position includes a position near the end of the next advertisement.

11. A content distributor as recited in claim 10, wherein the focal position is approximately five seconds from the end of the next advertisement.

12. A content distributor as recited in claim 8, wherein:
the advertisement skip service is further configured to receive a play command from the media device to initiate rendering said next advertisement for viewing at the media device when the video stream is distributed to the media device from the focal position in said next advertisement; and
the media content server is further configured to distribute the video stream to the media device from a beginning of said next advertisement.

13. A content distributor as recited in claim 8, wherein the advertisement skip service is further configured to:
determine whether the advertisement that is being skipped is a last advertisement in the advertisement pod; and
skip to an end of the last advertisement if the advertisement that is being skipped is the last advertisement in the advertisement pod to distribute the video stream to the media device from the end of the last advertisement in the advertisement pod.

14. A content distributor as recited in claim 8, wherein the skip command is received as an auto-skip command, and wherein the advertisement skip service is further configured to:
determine a respective focal position in each subsequent advertisement in the advertisement pod and said skip to the focal position in the next advertisement until the next advertisement is a last advertisement in the advertisement pod; and
skip to an end of the last advertisement in the advertisement pod to distribute the video stream to the media device from the end of the last advertisement in the advertisement pod.

15. A media device, comprising:
a playback application configured to render a video stream of recorded media content as television media content for viewing, the recorded media content including one or more advertisement pods that each include one or more advertisements; and
a skip control module configured to:
receive a skip command to skip an advertisement in an advertisement pod that is rendered for viewing;
determine a focal position in a next advertisement in the advertisement pod that follows the advertisement which is being skipped; and
skip to the focal position in the next advertisement in the advertisement pod to render the recorded media content from the focal position in the next advertisement.

16. A media device as recited in claim 15, wherein the focal position is a beginning of the next advertisement.

17. A media device as recited in claim 15, wherein the skip control module is further configured to determine an end of the next advertisement, and wherein the focal position includes a position near the end of the next advertisement.

18. A media device as recited in claim 15, wherein the skip control module is further configured to:
receive a play command to initiate rendering said next advertisement for viewing after the recorded media content is rendered from the focal position in the next advertisement; and
skip to a beginning of said next advertisement to render the recorded media content from the beginning of said next advertisement.

19. A media device as recited in claim 15, wherein the skip control module is further configured to:
determine whether the advertisement that is being skipped is a last advertisement in the advertisement pod; and
skip to an end of the last advertisement if the advertisement that is being skipped is the last advertisement in the advertisement pod to render the recorded media content from the end of the last advertisement in the advertisement pod.

20. A media device as recited in claim 15, wherein the skip command is received as an auto-skip command, and wherein the skip control module is further configured to:
determine a respective focal position in each subsequent advertisement in the advertisement pod and said skip to the focal position in the next advertisement until the next advertisement is a last advertisement in the advertisement pod; and
skip to an end of the last advertisement in the advertisement pod to render the recorded media content from the end of the last advertisement in the advertisement pod.
